(19) United States
(12) Patent Application Publication
(10) Pub. No.: US 2016/0242414 A1
(43) Pub. Date: Aug. 25, 2016

(54) SAFENED HERBICIDAL COMPOSITIONS CONTAINING HALAUXIFEN OR 4-AMINO-3-CHLORO-5-FLUORO-6-(4-CHLORO-2-FLUORO-3-METHOXYPHENYL) PYRIDINE-2-CARBOXYLIC ACID AND METHODS OF USE THEREOF IN TURF

(71) Applicant: Dow AgroSciences LLC, Indianapolis, IN (US)

(72) Inventors: James M. Breuninger, Zionsville, IN (US); Anita L. Alexander, Lawrenceville, GA (US)

(73) Assignee: Dow AgroSciences LLC, Indianapolis, IN (US)

(21) Appl. No.: 15/014,271

(22) Filed: Feb. 3, 2016

Related U.S. Application Data
(60) Provisional application No. 62/118,596, filed on Feb. 20, 2015.

(51) Int. Cl. A01N 43/40; A01N 43/90; A01N 37/10

(52) U.S. Cl. CPC A01N 43/40; A01N 37/10; A01N 43/90

(57) ABSTRACT

Provided herein are safened herbicidal compositions for use in turfgrass susceptible to injury by halauxifen or 4-amino-3-chloro-5-fluoro-6-(4-chloro-2-fluoro-3-methoxyphenyl)pyridine-2-carboxylic acid comprising (a) a herbicidally effective amount of halauxifen, 4-amino-3-chloro-5-fluoro-6-(4-chloro-2-fluoro-3-methoxyphenyl)pyridine-2-carboxylic acid, or an agriculturally acceptable salt or ester of thereof, and (b) a compatible herbicide, or an agriculturally acceptable salt or ester thereof, capable of safening the halauxifen or 4-amino-3-chloro-5-fluoro-6-(4-chloro-2-fluoro-3-methoxyphenyl)pyridine-2-carboxylic acid to the turfgrass.

### CROSS REFERENCE TO RELATED PATENT APPLICATION

This application claims the benefit under 35 U.S.C. §119 (e) of provisional application Ser. No. 62/118,596 filed Feb. 20, 2015. This application is incorporated herein by reference in its entirety for all purposes.

### BACKGROUND

The protection of turfgrass from weeds and other vegetation which inhibit the growth of the turfgrass is a constantly recurring problem. To help combat this problem, researchers in the field of synthetic chemistry have produced an extensive variety of chemicals and chemical formulations effective in the control of such unwanted growth. Chemical herbicides of many types have been disclosed in the literature and a large number are in commercial use. Such herbicides, however, can injure the turfgrass in addition to the weeds and other vegetation intended to be controlled.

### SUMMARY

Provided herein are safened herbicidal compositions for use in turfgrass susceptible to injury by halauxifen or 4-amino-3-chloro-5-fluoro-6-(4-chloro-2-fluoro-3-methoxyphenyl)pyridine-2-carboxylic acid containing (a) a herbicidally effective amount of halauxifen, 4-amino-3-chloro-5-fluoro-6-(4-chloro-2-fluoro-3-methoxyphenyl)pyridine-2-carboxylic acid, an agriculturally acceptable salt or ester of thereof, or combinations thereof and (b) a compatible herbicide, or an agriculturally acceptable salt or ester thereof, capable of safening the halauxifen or 4-amino-3-chloro-5-fluoro-6-(4-chloro-2-fluoro-3-methoxyphenyl)pyridine-2-carboxylic acid to the turfgrass. The compositions may also contain one or more agriculturally acceptable adjuvants or carriers and additional inert ingredients.

Provided herein also are methods for safening turfgrass susceptible to injury from halauxifen or 4-amino-3-chloro-5-fluoro-6-(4-chloro-2-fluoro-3-methoxyphenyl)pyridine-2-carboxylic acid including applying to the turfgrass, contacting the vegetation, or area adjacent thereto with a herbicidal composition comprising (a) a herbicidally effective amount of halauxifen, 4-amino-3-chloro-5-fluoro-6-(4-chloro-2-fluoro-3-methoxyphenyl)pyridine-2-carboxylic acid, an agriculturally acceptable salt or ester thereof, or combinations thereof and (b) a compatible herbicide capable of safening the halauxifen or 4-amino-3-chloro-5-fluoro-6-(4-chloro-2-fluoro-3-methoxyphenyl)pyridine-2-carboxylic acid to the turfgrass.

In some embodiments, the compatible herbicide capable of safening the halauxifen or 4-amino-3-chloro-5-fluoro-6-(4-chloro-2-fluoro-3-methoxyphenyl)pyridine-2-carboxylic acid to the turfgrass susceptible to injury from the halauxifen or 4-amino-3-chloro-5-fluoro-6-(4-chloro-2-fluoro-3-methoxyphenyl)pyridine-2-carboxylic acid is one or more synthetic auxin herbicide including, but not limited to, 2,4-D, 2,4-DB, clopyralid, dicamba, fluroxypyr, MCPA, MCPB, triclopyr, agriculturally acceptable salts or esters thereof, and combinations thereof.

The compatible herbicide capable of safening the halauxifen to the turfgrass susceptible to injury from halauxifen or 4-amino-3-chloro-5-fluoro-6-(4-chloro-2-fluoro-3-methoxyphenyl)pyridine-2-carboxylic acid, may include at least one synthetic auxin herbicide selected from 2,4-D, dicamba, MCPA, agriculturally acceptable salts or esters thereof, and combinations thereof.

The turfgrasses susceptible to injury from halauxifen or 4-amino-3-chloro-5-fluoro-6-(4-chloro-2-fluoro-3-methoxyphenyl)pyridine-2-carboxylic acid, or an agriculturally acceptable salt or ester thereof, include, but are not limited to, perennial ryegrass (LOLPE), tall fescue (FESAR) and St. Augustine grass (STPSE).

### DETAILED DESCRIPTION

### I. Definitions

As used herein, halauxifen has the following structure:

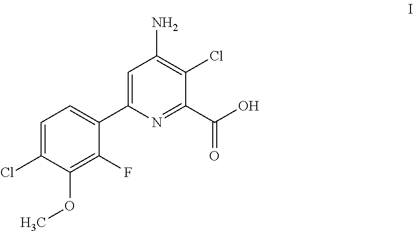 [SMILES: COc1c(Cl)ccc(-c2cc(N)c(Cl)c(C(=O)O)n2)c1F]

The compound of formula (I) can be identified by the name 4-amino-3-chloro-6-(4-chloro-2-fluoro-3-methoxyphenyl)pyridine-2-carboxylic acid and has been described in U.S. Pat. No. 7,314,849 (B2), which is incorporated herein by reference in its entirety. Exemplary uses of the compound of the formula (I), or an agriculturally acceptable salt or ester of thereof, include controlling undesirable vegetation, including grass, broadleaf and sedge weeds, in multiple non-crop and cropping situations.

As used herein, 4-amino-3-chloro-5-fluoro-6-(4-chloro-2-fluoro-3-methoxyphenyl)pyridine-2-carboxylic acid has the following structure:

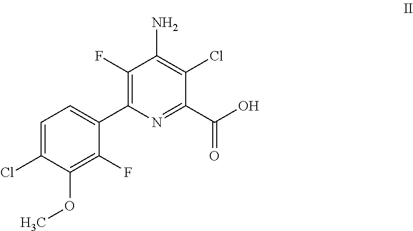 [SMILES: COc1c(Cl)ccc(-c2nc(C(=O)O)c(Cl)c(N)c2F)c1F]

The compound of formula (II) has been described in U.S. Pat. No. 7,314,849 (B2), which is incorporated herein by reference in its entirety. Exemplary uses of the compound of the formula (II), or an agriculturally acceptable salt or ester of thereof, include controlling undesirable vegetation, including grass, broadleaf and sedge weeds, in multiple non-crop and cropping situations.

As used herein, herbicide means an active ingredient that kills, controls, or otherwise adversely modifies the growth of plants.

As used herein, compatible herbicide refers to those herbicides, or agriculturally acceptable salts or esters thereof, when used to safen halauxifen, 4-amino-3-chloro-5-fluoro-6-(4-chloro-2-fluoro-3-methoxyphenyl)pyridine-2-carboxylic acid, or an agriculturally acceptable salt or ester thereof, to turfgrass, do not adversely impact the physical and/or biological properties of halauxifen, 4-amino-3-chloro-5-fluoro-6-(4-chloro-2-fluoro-3-methoxyphenyl)pyridine-2-carboxylic acid, or an agriculturally acceptable salt or ester thereof or compositions containing the same.

As used herein, a turfgrass susceptible to injury from halauxifen or 4-amino-3-chloro-5-fluoro-6-(4-chloro-2-fluoro-3-methoxyphenyl)pyridine-2-carboxylic acid is a turfgrass that upon contact with halauxifen or 4-amino-3-chloro-5-fluoro-6-(4-chloro-2-fluoro-3-methoxyphenyl)pyridine-2-carboxylic acid, or an agriculturally acceptable salt or ester thereof, experiences an adversely modifying effect such as, but not limited to, deviations from natural development, growth regulation, desiccation, growth retardation, plant death, and the like.

As used herein, plants and vegetation include, but are not limited to, germinant seeds, emerging seedlings, plants emerging from vegetative propagules, and established vegetation.

Turfgrass to be protected from the adverse effects of undesirable plant growth may be damaged to a certain degree when an effective dose of an herbicide is used. Safening, as used herein, means preventing or reducing the adverse effect of a herbicide on the turfgrass, i.e., protecting the turfgrass without, at the same time, noticeably influencing (i.e., overly diminishing) the herbicidal action on the undesirable plant growth, i.e., weeds, to be combated.

Turfgrasses susceptible to injury from halauxifen or 4-amino-3-chloro-5-fluoro-6-(4-chloro-2-fluoro-3-methoxyphenyl)pyridine-2-carboxylic acid, or an agriculturally acceptable salt or ester thereof, include, but are not limited to, perennial ryegrass (LOLPE), tall fescue (FESAR) and St. Augustine grass (STPSE).

As used herein, agriculturally acceptable salts and esters refer to salts and esters that exhibit herbicidal activity or that are or can be converted in plants, water, or soil to the referenced herbicide. Exemplary agriculturally acceptable esters are those that are or can be hydrolyzed, oxidized, metabolized, or otherwise converted, e.g., in plants, water, or soil, to the corresponding carboxylic acid which, depending upon the pH, may be in the dissociated or undissociated form. Exemplary salts include those derived from alkali or alkaline earth metals and those derived from ammonia and amines. Exemplary cations include sodium, potassium, magnesium, and aminium cations of the formula:

R¹R²R³R⁴N⁺

wherein R¹, R², R³ and R⁴ each, independently represents hydrogen or C₁-C₁₂ alkyl, C₃-C₁₂ alkenyl or C₃-C₁₂ alkynyl, each of which is optionally substituted by one or more hydroxy, C₁-C₄ alkoxy, C₁-C₄ alkylthio or phenyl groups, provided that R¹, R², R³ and R⁴ are sterically compatible. Additionally, any two of R¹, R², R³ and R⁴ together may represent an aliphatic difunctional moiety containing one to twelve carbon atoms and up to two oxygen or sulfur atoms. Salts can be prepared by treatment of the corresponding herbicidal carboxylic acid with a metal hydroxide, such as, for example, sodium hydroxide, with ammonia, with an amine, such as, for example, dimethylamine, trimethylamine, diethanolamine, 2-methyl-thiopropylamine, bisallylamine, 2-butoxyethylamine, morpholine, cyclododecylamine, or benzylamine or with a tetraalkylammonium hydroxide, such as, for example, tetramethylammonium hydroxide or choline hydroxide.

Exemplary esters include those derived from C₁-C₁₂ alkyl, C₃-C₁₂ alkenyl, C₃-C₁₂ alkynyl or C₇-C₁₀ aryl-substituted alkyl alcohols, such as methyl alcohol, isopropyl alcohol, 1-butanol, 2-ethylhexanol, butoxyethanol, methoxypropanol, 2-octanol, allyl alcohol, propargyl alcohol, cyclohexanol or unsubstituted or substituted benzyl alcohols. Benzyl alcohols may be substituted with from 1-3 substituents independently selected from halogen, C₁-C₄ alkyl or C₁-C₄ alkoxy. Esters can be prepared by coupling of the acids with the alcohol using any number of suitable activating agents such as those used for peptide couplings such as dicyclohexylcarbodiimide (DCC) or carbonyl diimidazole (CDI); by reacting the acids with alkylating agents such as alkylhalides or alkylsulfonates in the presence of a base such as triethylamine or lithium carbonate; by reacting the corresponding acid chloride of an acid with an appropriate alcohol; by reacting the corresponding acid with an appropriate alcohol in the presence of an acid catalyst or by transesterification.

### II. Compositions

Provided herein are safened herbicidal compositions for use in turfgrass susceptible to injury by halauxifen or 4-amino-3-chloro-5-fluoro-6-(4-chloro-2-fluoro-3-methoxyphenyl)pyridine-2-carboxylic acid containing: (a) an herbicidally effective amount of halauxifen or 4-amino-3-chloro-5-fluoro-6-(4-chloro-2-fluoro-3-methoxyphenyl)pyridine-2-carboxylic acid, or an agriculturally acceptable salt or ester thereof, and (b) a compatible herbicide, or an agriculturally acceptable salt, or ester thereof, capable of safening the halauxifen or 4-amino-3-chloro-5-fluoro-6-(4-chloro-2-fluoro-3-methoxyphenyl)pyridine-2-carboxylic acid to the turfgrass. The described compositions may also contain an agriculturally acceptable adjuvant or carrier and additional inert ingredients.

As used herein, the compatible herbicide, or an agriculturally acceptable salt, or ester thereof capable of safening the halauxifen or 4-amino-3-chloro-5-fluoro-6-(4-chloro-2-fluoro-3-methoxyphenyl)pyridine-2-carboxylic acid to the turfgrass may include a synthetic auxin herbicide. In some embodiments, the synthetic auxin herbicide includes, but is not limited to, one or more of 2,4-D, 2,4-DB, clopyralid, dicamba, fluroxypyr, MCPA, MCPB, triclopyr, and agriculturally acceptable salts or esters thereof. In some embodiments, the synthetic auxin herbicide includes 2,4-D, dicamba, MCPA, and agriculturally acceptable salts or esters thereof.

In some embodiments, the compositions and methods described herein may include the use of halauxifen-methyl or 4-amino-3-chloro-5-fluoro-6-(4-chloro-2-fluoro-3-methoxyphenyl)pyridine-2-carboxylic acid and the compatible herbicide is 2,4-D, or an agriculturally acceptable salt or ester thereof.

In some embodiments, the compositions and methods described herein may include halauxifen-methyl or 4-amino-3-chloro-5-fluoro-6-(4-chloro-2-fluoro-3-methoxyphenyl)pyridine-2-carboxylic acid and the compatible herbicide is 2,4-D dimethylamine.

In some embodiments, the compositions and methods described herein may include halauxifen-methyl or 4-amino-3-chloro-5-fluoro-6-(4-chloro-2-fluoro-3-methoxyphenyl)pyridine-2-carboxylic acid and the compatible herbicide is 2,4-D choline.

In some embodiments, the compositions and methods described herein may include halauxifen-methyl or 4-amino-3-chloro-5-fluoro-6-(4-chloro-2-fluoro-3-methoxyphenyl)pyridine-2-carboxylic acid and the compatible herbicide is dicamba, or an agriculturally acceptable salt or ester thereof.

In some embodiments, the compositions and methods described herein may include halauxifen-methyl or 4-amino-3-chloro-5-fluoro-6-(4-chloro-2-fluoro-3-methoxyphenyl)pyridine-2-carboxylic acid and the compatible herbicide is dicamba dimethylamine.

In some embodiments, the compositions and methods described herein may include halauxifen-methyl or 4-amino-3-chloro-5-fluoro-6-(4-chloro-2-fluoro-3-methoxyphenyl)pyridine-2-carboxylic acid and the compatible herbicide is MCPA, or an agriculturally acceptable salt or ester thereof.

In some embodiments, the compositions and methods described herein may include halauxifen-methyl or 4-amino-3-chloro-5-fluoro-6-(4-chloro-2-fluoro-3-methoxyphenyl)pyridine-2-carboxylic acid and the compatible herbicide is MCPA ethylhexyl ester.

In some embodiments, the compositions and methods described herein may include halauxifen-methyl or 4-amino-3-chloro-5-fluoro-6-(4-chloro-2-fluoro-3-methoxyphenyl)pyridine-2-carboxylic acid and the compatible herbicide is MCPA potassium.

In the compositions and methods described herein, an agriculturally acceptable ester or salt of halauxifen is employed. An agriculturally acceptable ester, such as an aralkyl or alkyl ester, can be employed. The ester can be a C₁-C₄ alkyl ester, a methyl ester, a n-butyl ester, a benzyl ester, or a substituted benzyl ester. Additionally, the carboxylic acid form or the carboxylate salt of the halauxifen may be used.

In the compositions and methods described herein, the halauxifen or a salt or ester thereof, is used in combination with a compatible herbicide capable of safening the halauxifen to the turfgrass. The weight ratio of the halauxifen or a salt or ester thereof to the compatible herbicide capable of safening the halauxifen to the turfgrass is within the range of from 1:100 to 25:1. The weight ratio of the halauifen or a salt or ester thereof, to the compatible herbicide capable of safening the halauxifen to the turfgrass can also be within the range from 1:90 to 25:1, 1:80 to 25:1, 1:70 to 25:1, 1:60 to 25:1, 1:50 to 25:1, 1:40 to 25:1, 1:30 to 25:1, 1:20 to 25:1, 1:18 to 25:1, 1:16 to 25:1, 1:14 to 25:1, 1:12 to 25:1, 1:10 to 25:1, 1:8 to 25:1, 1:6 to 25:1, 1:5 to 25:1, 1:4 to 25:1, 1:3 to 25:1, 1:2 to 25:1, 1:1 to 25:1, 1:100 to 20:1, 1:100 to 18:1, 1:100 to 16:1, 1:100 to 14:1, 1:100 to 12:1, 1:100 to 10:1, 1:100 to 9:1, 1:100 to 8:1, 1:100 to 7:1, 1:100 to 6:1, 1:100 to 5:1, 1:100 to 4:1, 1:100 to 3:1, 1:100 to 2:1, 1:100 to 1:1, 1:50 to 20:1, 1:40 to 20:1, 1:30 to 20:1, 1:25 to 15:1, 1:20 to 15:1, 1:18 to 12:1, 1:16 to 10:1, 1:14 to 10:1, 1:12 to 10:1, 1:10 to 1:1, 1:9 to 1:1, 1:8 to 1:1, 1:7 to 1:1, 1:6 to 1:1, 1:5 to 1:1, 1:4 to 1:1, 1:3 to 1:1, or 1:2 to 1:1. Additionally, the weight ratio of the halauxifen or a salt or ester thereof to the compatible herbicide capable of safening the halauxifen to the turfgrass can be 25:1, 20:1, 18:1, 16:1, 14:1, 12:1, 10:1, 9:1, 8:1, 7:1, 6:1, 5:1, 4:1, 3:1, 2:1, 1.9:1, 1.8:1, 1.7:1, 1.6:1, 1.5:1, 1.4:1, 1.3:1, 1.2:1, 1.1:1, 1:1, 1:1.1, 1:1.2, 1:1.3, 1:1.4, 1:1.5, 1:1.6, 1:1.7, 1:1.8, 1:1.9, 1:2, 1:2.1, 1:2.2, 1:2.3, 1:2.4, 1:2.5, 1:2.6, 1:2.7, 1:2.8, 1:2.9, 1:3, 1:3.1, 1:3.2, 1:3.3, 1:3.4, 1:3.5, 1:3.6, 1:3.7, 1:3.8, 1:3.9, 1:4, 1:4.1, 1:4.2, 1:4.3, 1:4.4, 1:4.5, 1:4.6, 1:4.7, 1:4.8, 1:4.9, 1:5, 1:6, 1:7, 1:8, 1:9, 1:10, 1:11, 1:12, 1:13, 1:14, 1:15, 1:16, 1:18, 1:20, 1:25, 1:30, 1:35, 1:40, 1:45, 1:50, 1:60, 1:75, or 1:100.

The safened compositions can further, be used in conjunction with glyphosate, 5-enolpyruvylshikimate-3-phosphate (EPSP) synthase inhibitors, glufosinate, glutamine synthetase inhibitors, dicamba, phenoxy auxins, pyridyloxy auxins, synthetic auxins, auxin transport inhibitors, aryloxyphenoxypropionates, cyclohexanediones, phenylpyrazolines, acetyl CoA carboxylase (ACCase) inhibitors, imidazolinones, sulfonylureas, pyrimidinylthiobenzoates, triazolopyrimidines, sulfonylaminocarbonyltriazolinones, acetolactate synthase (ALS) or acetohydroxy acid synthase (AHAS) inhibitors, 4-hydroxyphenyl-pyruvate dioxygenase (HPPD) inhibitors, phytoene desaturase inhibitors, carotenoid biosynthesis inhibitors, protoporphyrinogen oxidase (PPO) inhibitors, cellulose biosynthesis inhibitors, mitosis inhibitors, microtubule inhibitors, very long chain fatty acid inhibitors, fatty acid and lipid biosynthesis inhibitors, photosystem I inhibitors, photosystem II inhibitors, triazines, and bromoxynil.

The safened herbicide mixtures described herein can be applied in conjunction with one or more other herbicides to control a wider variety of undesirable vegetation. When used in conjunction with other herbicides, the composition can be formulated with the other herbicide or herbicides, tank-mixed with the other herbicide or herbicides, or applied sequentially with the other herbicide or herbicides. Some of the herbicides that can be employed in conjunction with the compositions and methods described herein include, but are not limited to: 4-CPA, 4-CPB, 4-CPP, 3,4-DA, 3,4-DB, 2,4-DEB, 2,4-DEP, 3,4-DP, 2,3,6-TBA, 2,4,5-T, 2,4,5-TB, acetochlor, acifluorfen, aclonifen, alachlor, allidochlor, alloxydim, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, benthiocarb, bentazon-sodium, benzadox, benzfendizone, benzipram, benzobicyclon, benzofenap, benzofluor, benzoylprop, benzthiazuron, bialaphos, bicyclopyrone, bifenox, bilanafos, bispyribac-sodium, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop-propargyl, clofop, clomazone, clomeprop, cloprop, cloproxydim, cloransulam-methyl, CMA, copper sulfate, CPMF, CPPC, credazine, cresol, cumyluron, cyanatryn, cyanazine, cycloate, cyclopyrimorate, cyclosulfamuron, cycloxydim, cycluron, cyhalofop-butyl, cyperquat, cyprazine, cyprazole, cypromid, dalapon, dazomet, delachlor, desmedipham, desmetryn, di-allate, dichlobenil, dichloralurea, dichlormate, dichlorprop, dichlorprop-P, diclofop-methyl, diclosulam, diethamquat, diethatyl, difenopenten, difenoxuron, difenzoquat, diflufenican, diflufenzopyr, dimefuron, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethametsulfuron, ethidimuron, ethiolate, ethofumesate, ethoxyfen, ethoxysulfuron, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenteracol, fenthiaprop, fentrazamide, fenuron, flamprop, flamprop-M, flazasulfuron, florasulam, fluazifop, fluazifop-P-butyl, fluazolate, flucarbazone, flucetosulfuron, fluchloralin, flufenacet, flufenican, flufenpyr-ethyl, flumetsulam, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, flurtamone, fluthiacet, fomesafen, foramsulfuron, fosamine, fumiclorac, furyloxyfen, glufosinate salts and esters, glufosinate-ammonium, glufosinate-P-ammonium, glyphosate salts and esters, halosafen, halosulfuron-methyl, haloxydine, haloxyfop-methyl, haloxyfop-P-methyl, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl isothiocyanate, methyldymron, metobenzuron, metobromuron, metolachlor, metosulam, metoxuron, metribuzin, metsulfuron, metsulfuron-methyl, molinate, monalide, monisouron, monochloroacetic acid, monolinuron, monuron, morfamquat, MSMA, naproanilide, napropamide, napropamide-M, naptalam, neburon, nicosulfuron, nipyraclofen, nitralin, nitrofen, nitrofluorfen, norflurazon, noruron, orbencarb, orthosulfamuron, oryzalin, oxadiargyl, oxadiazon, oxapyrazon, oxasulfuron, oxaziclomefone, oxyfluorfen, paraflufen-ethyl, parafluron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron-methyl, procyazine, prodiamine, profluazol, profluralin, profoxydim, proglinazine, prohexadione-calcium, prometon, prometryn, pronamide, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen-ethyl, pyrasulfotole, pyrazogyl, pyrazolynate, pyrazosulfuron-ethyl, pyrazoxyfen, pyribenzoxim, pyributicarb, pyriclor, pyridafol, pyridate, pyriftalid, pyriminobac, pyrimisulfan, pyrithiobac-sodium, pyroxasulfone, pyroxsulam, quinclorac, quinmerac, quinoclamine, quinonamid, quizalofop, quizalofop-P-ethyl, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, SYN-523, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thifensulfuron-methyl, thiobencarb, tiocarbazil, tioclorim, topramezone, tralkoxydim, triafamone, tri-allate, triasulfuron, triaziflam, tribenuron, tribenuron-methyl, tricamba, tridiphane, trietazine, trifloxysulfuron, trifluralin, triflusulfuron, trifop, trifopsime, trihydroxytriazine, trimeturon, tripropindan, tritac, tritosulfuron, vernolate, xylachlor and salts, esters, optically active isomers and mixtures thereof.

In some embodiments, the compositions described herein are employed in combination with one or more plant growth regulators, such as 2,3,5-tri-iodobenzoic acid, IAA, IBA, naphthaleneacetamide, α-naphthaleneacetic acids, benzyladenine, 4-hydroxyphenethyl alcohol, kinetin, zeatin, endothal, pentachlorophenol, thidiazuron, tribufos, aviglycine, ethephon, maleic hydrazide, gibberellins, gibberellic acid, abscisic acid, ancymidol, fosamine, glyphosine, isopyrimol, jasmonic acid, maleic hydrazide, mepiquat, morphactins, dichlorflurenol, flurprimidol, mefluidide, paclobutrazol, tetcyclacis, uniconazole, brassinolide, brassinolide-ethyl, cycloheximide, ethylene, methasulfocarb, prohexadione, triapenthenol, and trinexapac-ethyl. In some embodiments, the plant growth regulator is mixed with the halauxifen to cause a preferentially advantageous effect on plants.

The compositions provided herein can further include one or more agriculturally acceptable adjuvant or carrier. Suitable adjuvants or carriers should not be phytotoxic to the turfgrass, particularly at the concentrations employed in applying the compositions for selective weed control in the presence of the turfgrass and should not react chemically with herbicidal components or other composition ingredients. Such mixtures can be designed for application directly to weeds or their locus or can be concentrates or formulations that are normally diluted with additional carriers and adjuvants before application. The adjuvants or carriers can be solids, such as, for example, dusts, granules, water-dispersible granules, or wettable powders, or liquids, such as, for example, emulsifiable concentrates, solutions, emulsions or suspensions. Additionally, the adjuvants or carriers can also be provided as a pre-mix or tank-mixed.

Suitable agricultural adjuvants and carriers are well known to those of skill in the art and include, but are not limited to, crop oil concentrate; nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO); PEG(400) dioleate-99.

Examples of liquid carriers that can be used in the compositions and methods described herein include water and organic solvents. Examples of useful organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. Water is useful as a carrier for the dilution of concentrates.

Suitable solid carriers include but are not limited to talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, cellulose, and the like.

The compositions described herein may further include one or more surface-active agents. Such surface-active agents can be used in both solid and liquid compositions, and can be designed to be diluted with a carrier before application. The surface-active agents can be anionic, cationic or nonionic in character and can be employed as emulsifying agents, wetting agents, suspending agents, or for other purposes. Surfactants which may also be used in the present formulations are described, inter alia, in McCutcheon's Detergents and Emulsifiers Annual, MC Publishing Corp.: Ridgewood, N.J., 1998 and in Encyclopedia of Surfactants, Vol. I-III, Chemical Publishing Co.: New York, 1980-81. Surface-active agents include, but are not limited to salts of alkyl sulfates, such as diethanolammonium lauryl sulfate; alkylarylsulfonate salts, such as calcium dodecylbenzenesulfonate; alkylphenol-alkylene oxide additionproducts, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, e.g., methyl esters. These materials, such as vegetable or seed oils and their esters, can be used interchangeably as an agricultural adjuvant, as a liquid carrier or as a surface active agent.

Other additives useful in the compositions provided herein include, but are not limited to, compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

The concentration of active ingredients in the compositions described herein is generally from 0.0005 to 98 percent by weight. Additionally, concentrations from 0.0006 to 90 percent by weight can be used. In compositions designed to be employed as concentrates, the active ingredients can be present in a concentration from 0.1 to 98 weight percent or from 0.5 to 90 weight percent. Such compositions can be diluted with an inert carrier, such as, for example, water, before application. The diluted compositions usually applied to vegetation or the soil adjacent thereto can contain from 0.0006 to 15.0 weight percent active ingredient or from 0.001 to 10.0 weight percent active ingredient.

### III. Methods of Use

Provided herein also are methods for safening turfgrass susceptible to injury from halauxifen or 4-amino-3-chloro-5-fluoro-6-(4-chloro-2-fluoro-3-methoxyphenyl)pyridine-2-carboxylic acid, including applying to the turfgrass, contacting the vegetation, or area adjacent thereto with a herbicidal composition containing (a) a herbicidally effective amount of halauxifen or 4-amino-3-chloro-5-fluoro-6-(4-chloro-2-fluoro-3-methoxyphenyl)pyridine-2-carboxylic acid, an agriculturally acceptable salt or ester thereof, or combinations thereof and (b) a compatible herbicide capable of safening the halauxifen to the turfgrass.

The halauxifen, 4-amino-3-chloro-5-fluoro-6-(4-chloro-2-fluoro-3-methoxyphenyl)pyridine-2-carboxylic acid, or an agriculturally acceptable salt or ester of thereof and the compatible herbicide capable of safening the halauxifen or 4-amino-3-chloro-5-fluoro-6-(4-chloro-2-fluoro-3-methoxyphenyl)pyridine-2-carboxylic acid to turfgrass as described herein, can be applied either separately or together as part of a system. When part of a system, for example, the halauxifen, 4-amino-3-chloro-5-fluoro-6-(4-chloro-2-fluoro-3-methoxyphenyl)pyridine-2-carboxylic acid, or an agriculturally acceptable salt or ester of thereof and the compatible herbicide capable of safening the halauxifen or 4-amino-3-chloro-5-fluoro-6-(4-chloro-2-fluoro-3-methoxyphenyl)pyridine-2-carboxylic acid to turfgrass as described herein, can be formulated in one composition, tank-mixed, applied simultaneously, or applied sequentially. The halauxifen, 4-amino-3-chloro-5-fluoro-6-(4-chloro-2-fluoro-3-methoxyphenyl)pyridine-2-carboxylic acid, or an agriculturally acceptable salt or ester of thereof and the compatible herbicide capable of safening the halauxifen or 4-amino-3-chloro-5-fluoro-6-(4-chloro-2-fluoro-3-methoxyphenyl)pyridine-2-carboxylic acid to turfgrass as described herein, can be applied pre-emergently to the turfgrass or the undesirable vegetation or post-emergently to the turfgrass or the undesirable vegetation.

Herbicidal activity is exhibited by the halauxifen, 4-amino-3-chloro-5-fluoro-6-(4-chloro-2-fluoro-3-methoxyphenyl)pyridine-2-carboxylic acid, or an agriculturally acceptable salt or ester of thereof, when it is applied directly to a plant or to the area adjacent to the plant at any stage of growth. The herbicidal activity observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, and the like, as well as the amount of chemical applied. These and other factors can be adjusted to promote non-selective or selective herbicidal action. The compositions of halauxifen or 4-amino-3-chloro-5-fluoro-6-(4-chloro-2-fluoro-3-methoxyphenyl)pyridine-2-carboxylic acid described herein may be applied as a post-emergence application, or pre-emergence application, to relatively immature undesirable vegetation to achieve the maximum control of the undesirable vegetation.

The application rate will depend upon the particular type of weed to be controlled, the degree of control required, and the timing and method of application. In the compositions described herein the halauxifen, or a salt or ester thereof, can be applied at an application rate of from 1 gram acid equivalent per hectare (g ae/ha) to 200 g ae/ha based on the total amount of the halauxifen, or a salt or ester thereof, in the composition. Additionally, in the compositions described herein the halauxifen, or a salt or ester thereof, can be applied at an application rate of from 1 g ae/ha to 175 g ae/ha, 5 g ae/ha to 150 g ae/ha, 1 g ae/ha to 100 g ae/ha, 5 g ae/ha to 200 g ae/ha, 10 g ae/ha to 200 g ae/ha, 12.5 g ae/ha to 150 g ae/ha, 12.5 g ae/ha to 200 g ae/ha, 1 g ae/ha to 150 g ae/ha, 1 g ae/ha to 100 g ae/ha, 1 g ae/ha to 75 g ae/ha, 1 g ae/ha to 50 g ae/ha, 1 g ae/ha to 35 g ae/ha, 1 g ae/ha to 30 g ae/ha, 1 g ae/ha to 25 g ae/ha, 1 g ae/ha to 20 g ae/ha, 1 g ae/ha to 15 g ae/ha, 1 g ae/ha to 10 g ae/ha, 1 g ae/ha to 8 g ae/ha, 1 g ae/ha to 6 g ae/ha, 1 g ae/ha to 4 g ae/ha, 5 g ae/ha to 35 g ae/ha, 5 g ae/ha to 30 g ae/ha, 5 g ae/ha to 20 g ae/ha, 5 g ae/ha to 15 g ae/ha, or 5 g ae/ha to 10 g ae/ha based on the total amount of the halauxifen, or a salt or ester thereof, in the composition. In the compositions described herein the compatible herbicide capable of safening the halauxifen to the turfgrass can be applied at an application rate of from 1 g ae/ha to 3000 g ae/ha. Additionally, in the compositions described herein the compatible herbicide capable of safening the halauxifen to the turfgrass can be applied at an application rate of from 1 g ae/ha to 2800 g ae/ha, 1 g ae/ha to 2600 g ae/ha, 1 g ae/ha to 2400 g ae/ha, 1 g ae/ha to 2200 g ae/ha, 1 g ae/ha to 2000 g ae/ha, 1 g ae/ha to 1800 g ae/ha, 1 g ae/ha to 1600 g ae/ha, 1 g ae/ha to 1400 g ae/ha, 1 g ae/ha to 1200 g ae/ha, 1 g ae/ha to 1000 g ae/ha, 1 g ae/ha to 900 g ae/ha, 1 g ae/ha to 800 g ae/ha, 1 g ae/ha to 700 g ae/ha, 1 g ae/ha to 600 g ae/ha, 1 g ae/ha to 500 g ae/ha, 1 g ae/ha to 400 g ae/ha, 1 g ae/ha to 300 g ae/ha, 1 g ae/ha to 200 g ae/ha, 1 g ae/ha to 100 g ae/ha, 1 g ae/ha to 50 g ae/ha, 1 g ae/ha to 10 g ae/ha, 1 g ae/ha to 4 g ae/ha, 50 g ae/ha to 2800 g ae/ha, 50 g ae/ha to 2600 g ae/ha, 50 g ae/ha to 2400 g ae/ha, 50 g ae/ha to 2200 g ae/ha, 50 g ae/ha to 2000 g ae/ha, 50 g ae/ha to 1800 g ae/ha, 50 g ae/ha to 1600 g ae/ha, 50 g ae/ha to 1400 g ae/ha, 50 g ae/ha to 1200 g ae/ha, 50 g ae/ha to 1000 g ae/ha, 50 g ae/ha to 900 g ae/ha, 50 g ae/ha to 800 g ae/ha, 50 g ae/ha to 700 g ae/ha, 50 g ae/ha to 600 g ae/ha, 50 g ae/ha to 500 g ae/ha, 50 g ae/ha to 400 g ae/ha, 50 g ae/ha to 300 g ae/ha, 50 g ae/ha to 200 g ae/ha, 300 g ae/ha to 3000 g ae/ha, 400 g ae/ha to 3000 g ae/ha, 500 g ae/ha to 3000 g ae/ha, 600 g ae/ha to 3000 g ae/ha, 600 g ae/ha to 2800 g ae/ha, 700 g ae/ha to 2600 g ae/ha, 800 g ae/ha to 2500 g ae/ha, 800 g ae/ha to 2300 g ae/ha, 800 g ae/ha to 2100 g ae/ha, 800 g ae/ha to 1900 g ae/ha, 800 g ae/ha to 1700 g ae/ha, 900 g ae/ha to 1700 g ae/ha, 1000 g ae/ha to 1700 g ae/ha, or 1100 g ae/ha to 1700 g ae/ha, based on the total amount of the compatible herbicide capable of safening the halauxifen to the turfgrass in the composition. For example, the compatible herbicide capable of safening the halauxifen to the turfgrass may be applied at a rate from 1 g ae/ha to 3000 g ae/ha and the halauxifen, or a salt or ester thereof, may be applied at a rate from 1 g ae/ha to 200 g ae/ha.

The components of the mixtures described herein can be applied either separately or as part of a multipart herbicidal system.

The compositions and methods provided herein can be used to control weeds in turfgrasses, and also in glyphosate-tolerant, 5-enolpyruvylshikimate-3-phosphate (EPSP) synthase inhibitor-tolerant, glufosinate-tolerant, glutamine synthetase inhibitor-tolerant, dicamba-tolerant, imidazolinone-tolerant, sulfonylurea-tolerant, pyrimidinylthiobenzoate-tolerant, triazolopyrimidine-tolerant, sulfonylaminocarbonyltriazolinone-tolerant, phenoxy auxin-tolerant, pyridyloxy auxin-tolerant, auxin-tolerant, auxin transport inhibitor-tolerant, aryloxyphenoxypropionate-tolerant, acetyl CoA carboxylase (ACCase) inhibitor-tolerant, acetolactate synthase (ALS) or acetohydroxy acid synthase (AHAS) inhibitor-tolerant, 4-hydroxyphenyl-pyruvate dioxygenase (HPPD) inhibitor-tolerant, phytoene desaturase inhibitor-tolerant, carotenoid biosynthesis inhibitor-tolerant, protoporphyrinogen oxidase (PPO) inhibitor-tolerant, cellulose biosynthesis inhibitor-tolerant, mitosis inhibitor-tolerant, microtubule inhibitor-tolerant, very long chain fatty acid inhibitor-tolerant, fatty acid and lipid biosynthesis inhibitor-tolerant, photosystem I inhibitor-tolerant, photosystem II inhibitor-tolerant, triazine-tolerant and bromoxynil-tolerant turfgrasses. The compositions and methods provided herein can be used applied to nursery turfgrasses, pre-plant treatments and post-emergence treatments to turfgrasses. The compositions and methods may be used in controlling undesirable vegetation in turfgrasses genetically transformed to express specialized traits. Examples of specialized traits may include agronomic stress tolerance (including but not limited to drought, cold, heat, salt, water, nutrient, fertility, pH), pest tolerance (including but not limited to insects, fungi and pathogens) and crop improvement traits (including but not limited to yield; protein, carbohydrate, or oil content; protein, carbohydrate, or oil composition; plant stature and plant architecture). Additional examples include those expressing proteins toxic to invertebrate pests, such as Bacillus thuringiensis or other insecticidal toxins, or those with multiple or “stacked” foreign genes expressing insecticidal toxins, herbicide resistance, nutrition-enhancement and/or other beneficial traits, for example, grasses possessing multiple or stacked traits conferring tolerance to multiple chemistries and/or multiple modes-of-action via single and/or multiple resistance mechanisms.

The halauxifen, 4-amino-3-chloro-5-fluoro-6-(4-chloro-2-fluoro-3-methoxyphenyl)pyridine-2-carboxylic acid, or a salt or ester thereof, and the compatible herbicide, or salt or ester thereof capable of safening the halauxifen or 4-amino-3-chloro-5-fluoro-6-(4-chloro-2-fluoro-3-methoxyphenyl)pyridine-2-carboxylic acid to the turfgrass, can be used in combination with herbicides that are selective to the turfgrass, and which complement the spectrum of weeds controlled by the halauxifen or 4-amino-3-chloro-5-fluoro-6-(4-chloro-2-fluoro-3-methoxyphenyl)pyridine-2-carboxylic acid and the compatible herbicide. The compositions described herein and the complementary herbicides can be applied at the same time, either as a combination formulation, as a tank-mix or sequentially.

The compositions and methods may be used in controlling undesirable vegetation in turfgrasses possessing agronomic stress tolerance (including but not limited to drought, cold, heat, salt, water, nutrient, fertility, pH), pest tolerance (including but not limited to insects, fungi and pathogens) and crop improvement traits (including but not limited to yield; protein, carbohydrate, or oil content; protein, carbohydrate, or oil composition; plant stature and plant architecture).

The present compositions can be applied to vegetation or the soil or water adjacent thereto by the use of conventional ground or aerial dusters, sprayers, and granule applicators, by addition to irrigation or paddy water, and by other conventional means known to those skilled in the art.

The following Examples are presented to illustrate various aspects of the compositions and methods described herein and should not be construed as limitations to the claims.

### EXAMPLES

### Example 1

### Evaluation of Postemergence Herbicidal Safening of Halauxifen-Methyl in Turfgrass

Biology Materials and Methods

For the ryegrass and tall fescue experiments, research trials were conducted in Indiana at the William H Daniel Turfgrass Research center in West Lafayette, Ind. on well established 10 year old stands of perennial ryegrass and tall fescue that were maintained as a home lawn with regular fertilization, irrigation and a 7.5 cm mowing height. To begin the trial, the research areas were sub-divided into 3 replications of 2.3 m² plots in a completely randomized block design for each grass species and spray mixtures were prepared just prior to the treatment by mixing the formulations with water.

Herbicide treatments were applied to ryegrass and tall fescue turfgrass plots in spray applications that included the spray adjuvant Activator 90 at 0.25% (v/v). The plots were treated with a hand held CO2 backpack sprayer equipped with a 3 liter bottle that delivered 804 liters/ha of spray to each plot using a flat fan nozzle. No irrigation, rainfall or mowing occurred until 24 hours after the application. The temperature at the time of the application was 24° C. and the wind speed averaged 4.8 km/hr. There was no cloud cover during the application and the soil was moist. Visual evaluations were made of turf injury for each plot on a 0%-100% scale where 0%=no injury and 100%=death at 0, 7, 14, 28 and 42 days after the application. The results are shown in Tables 1-4.

An additional set of herbicide treatments were applied to ryegrass and tall fescue turfgrass plots as described above, but with no adjuvant. The temperature at the time of the treatment was 29° C. with an average wind speed of 6.4 km/hr. There was no cloud cover at this time and the soil was moist. Visual observations were made as described previously. The results are shown in Table 5.

A research trial was conducted at Riverside Circle Park in Naples, Fla. on established St. Augustine grass turf with routine turf maintenance practices. To begin the trial the turf area was subdivided into 4 replications of 2.3 m² plots in a completely randomized block design. Spray mixtures were prepared just prior to the treatment by mixing the formulations with water. Single applications of the herbicide treatments were made to all plots and then a second application was made to select plots 26 days later. All the spray treatments included the spray adjuvant MSO at 1.0% v/v. The applications were made with a handheld precision pump type sprayer calibrated to deliver 402 liters/ha of spray to each plot with hollow cone nozzle. Twenty hours after the application 1.25 cm of water was irrigated onto the turf. The air temperature at the time of the application was 24° C. for both applications and cloud cover was at 10%. Visual observations were made at 26 and 42 days after the first application as a % turf injury for each plot. The results are shown in Table 6.

Colby's equation was used to determine the herbicidal effects expected from the mixtures evaluated in the described trials (Colby, S. R. Calculation of the synergistic and antagonistic response of herbicide combinations. Weeds 1967, 15, 20-22).

The following equation was used to calculate the expected activity of mixtures containing two active ingredients, A and B:

Expected=A+B−(A×B/100)
A=observed efficacy of active ingredient A at the same concentration as used in the mixture;
B=observed efficacy of active ingredient B at the same concentration as used in the mixture.

Herbicide Treatments

(a) Concentrate A: A standard suspension concentrate (SC) containing 96 g ae/L of solid halauxifen-methyl particles suspended in water.

(b) Concentrate B: DMA® 4 IVM herbicide (contains 456 g ae/L of 2,4-D dimethyl ammonium in water).

(c) Concentrate C: Banvel®4S herbicide (contains 480 g ae/L dicamba dimethyl ammonium in water).

(d) Concentrate D: An halauxifen-methyl/fluroxypyr-meptyl concentrate solution in Genagen 4166 solvent was prepared by dissolving halauxifen-methyl (2.25 active ingredient (ai) wt %) and fluroxypyr-meptyl (48.36 ai wt %) in Genagen 4166 solvent (49.39 wt %) with mixing until a clear solution was obtained at ambient temperature. To 13.33 g of the halauxifen-methyl/fluroxypyr-meptyl concentrate solution prepared above was added additional Genagen 4166 solvent (12.42 g), Atlox 4912 (0.25 g), and Atlox DP 13/6 (2.0 g) followed by hand mixing to provide a homogeneous organic phase, to which 72.0 g of a 2,4-D choline aqueous concentrate (prepared by reacting 2,4-D acid technical with an equimolar amount of choline hydroxide in water at ambient temperature; additional water was then added to reach a target 2,4-D acid equivalent (ae) concentration of 45.7 wt %) was added. Upon mild hand mixing, a transparent and homogenous solution was formed containing 48.25 wt % ai (377 g ae/L) of 2,4-D choline, 0.30 wt % ai (3.3 g ae/L) of halauxifen-methyl and 6.45 wt % ai (51.3 g ae/L) of fluroxypyr-meptyl.

(e) Concentrate E: Paradigm® herbicide (contains 200 g ae/kg of halauxifen-methyl and 200 g ai/kg of florasulam in a water dispersible granule).

(f) Concentrate F: Rifle® herbicide (contains 480 g ae/L of dicamba dimethyl ammonium in water).

The compositions tested, application rates employed, plant species tested, and results are given in Table 1 through Table 6.

TABLE 1
SAFENING ACTIVITY OF 2,4-D ON PERENNIAL RYEGRASS
(LOLPE) TREATED WITH HALAUXIFEN-METHYL
AT 28 DAYS AFTER APPLICATION

| Halauxifen- | 2,4-D | | | |
|---|---|---|---|---|
| Methyl¹ | DMA² | Observed | Expected | Probability of |
| Rate (g ae/ha)⁴ | | Injury³ | Injury³ | Occurrence |
| 15 | | 23 | | |
| 30 | | 33 | | |
| 45 | | 40 | | |
| | 840 | 3 | | |
| | 1120 | 7 | | |
| | 1680 | 0 | | |
| | 2520 | 10 | | |
| 15 | 840 | 23 | 26 | |
| 15 | 1120 | 7 | 30 | |
| 30 | 1120 | 2 | 40 | |
| 45 | 1120 | 13 | 46 | 0.01 |
| 30 | 1680 | 10 | 33 | |
| 45 | 2520 | 20 | 49 | 0.02 |

¹Concentrate A;
²Concentrate B;
³Injury is rated on a 0-100% scale where 0% = no injury and 100% = death;
⁴g ae/ha = grams acid equivalent per hectare.

TABLE 2
SAFENING ACTIVITY OF 2,4-D ON PERENNIAL RYEGRASS
(LOLPE) TREATED WITH HALAUXIFEN-METHYL
AT 42 DAYS AFTER APPLICATION

| Halauxifen- | 2,4-D | | | |
|---|---|---|---|---|
| Methyl¹ | DMA² | Observed | Expected | Probability of |
| Rate (g ae/ha)⁴ | | Injury³ | Injury³ | Occurrence |
| 15 | | 8 | | |
| 30 | | 12 | | |
| 45 | | 35 | | |
| | 840 | 0 | | |
| | 1120 | 0 | | |
| | 1680 | 0 | | |
| | 2520 | 0 | | |
| 15 | 840 | 0 | 8 | |
| 15 | 1120 | 7 | 8 | |
| 30 | 1120 | 2 | 12 | |
| 45 | 1120 | 13 | 35 | 0.01 |
| 30 | 1680 | 0 | 12 | 0.02 |
| 45 | 2500 | 5 | 35 | 0.02 |

¹Concentrate A;
²Concentrate B;
³Injury is rated on a 0-100% scale where 0% = no injury and 100% = death;
⁴g ae/ha = grams acid equivalent per hectare.

TABLE 3
SAFENING ACTIVITY OF DICAMBA ON PERENNIAL
RYEGRASS (LOLPE) TREATED WITH HALAUXIFEN-METHYL
AT 28 DAYS AFTER APPLICATION

| Halauxifen- | Dicamba | | | |
|---|---|---|---|---|
| Methyl¹ | DMA² | Observed | Expected | Probability of |
| Rate (g ae/ha)⁴ | | Injury³ | Injury³ | Occurrence |
| 30 | | 33 | | |
| | 280 | 7 | | |
| 30 | 280 | 10 | 40 | 0.02 |

¹Concentrate A;
²Concentrate C;
³Injury is rated on a 0-100% scale where 0% = no injury and 100% = death;
⁴g ae/ha = grams acid equivalent per hectare.

TABLE 4
SAFENING ACTIVITY OF DICAMBA ON TALL FESCUE
(FESAR) TREATED WITH HALAUXIFEN-METHYL AT 28
DAYS AFTER APPLICATION

| Halauxifen- | Dicamba | | | |
|---|---|---|---|---|
| Methyl¹ | DMA² | Observed | Expected | Probability of |
| Rate (g ae/ha)⁴ | | Injury³ | Injury³ | Occurrence |
| 30 | | 32 | | |
| | 280 | 0 | | |
| 30 | 280 | 3 | 32 | 0.07 |

¹Concentrate A;
²Concentrate C;
³Injury is rated on a 0-100% scale where 0% = no injury and 100% = death;
⁴g ae/ha = grams acid equivalent per hectare.

TABLE 5
SAFENING ACTIVITY OF 2,4-D ON PERENNIAL RYEGRASS
(LOLPE) AND TALL FESCUE (FESAR) TREATED WITH
HALAUXIFEN-METHYL AND FLUROXYPYR-MEPTYL
AT 30 DAYS AFTER APPLICATION

| Halauxifen- | 2,4-D | Fluroxypyr- | Observed | Observed |
|---|---|---|---|---|
| Methyl¹ | Choline¹ | Meptyl¹ | Injury² | Injury² |
| Rate (g ae/ha)³ | | | LOLPE | FESAR |
| 9 | 1100 | 150 | 0 | 0 |
| 18 | 2200 | 300 | 0 | 0 |
| 27 | 3300 | 450 | 0 | 0 |

¹Concentrate D;
²Injury is rated on a 0-100% scale where 0% = no injury and 100% = death;
³g ae/ha = grams acid equivalent per hectare.

TABLE 6
SAFENING ACTIVITY OF DICAMBA ON ST.
AUGUSTINEGRASS (STPSE) TREATED WITH
HALAUXIFEN-METHYL AND FLORASULAM
AT 26 AND 42 DAYS AFTER THE FIRST APPLICATION

| Halauxifen- | | Dicamba | Observed | Observed |
|---|---|---|---|---|
| Methyl¹ | Florasulam¹ | DMA² | Injury³ | Injury³ |
| Rate (g ae/ha or g ai/ha)⁴ | | | 26 DAA⁵ | 42 DAA⁶ |
| 10.1 | 10.1 | 0 | 40.0 | 26.3 |
| 10.1 | 10.1 | 146 | 0 | 0 |
| 10.1 + 10.1 | 10.1 + 10.1 | 0 | 50.0 | 52.5 |
| 10.1 + 10.1 | 10.1 + 10.1 | 146 | 0 | 15 |

¹Concentrate E;
²Concentrate F;
³Injury is rated on a 0-100% scale where 0% = no injury and 100% = death;
⁴g ae/ha = grams acid equivalent per hectare for halauxifen-methyl and dicamba DMA; g ai/ha = grams active ingredient per hectare for florasulam;
⁵26 days after first application;
⁶42 days after first application.

The present invention is not limited in scope by the embodiments disclosed herein which are intended as illustrations of a few aspects of the invention and any embodiments which are functionally equivalent are within the scope of this invention. Various modifications of the compositions and methods in addition to those shown and described herein will become apparent to those skilled in the art and are intended to fall within the scope of the appended claims. Further, while only certain representative combinations of the composition components and method steps disclosed herein are specifically discussed in the embodiments above, other combinations of the composition components and method steps will become apparent to those skilled in the art and also are intended to fall within the scope of the appended claims. Thus a combination of components or method steps may be explicitly mentioned herein; however, other combinations of components and method steps are included, even though not explicitly stated. The term comprising and variations thereof as used herein is used synonymously with the term including and variations thereof and are open, non-limiting terms.

What is claimed is:

1. A safened herbicidal composition for use in turfgrass susceptible to injury by halauxifen or 4-amino-3-chloro-5-fluoro-6-(4-chloro-2-fluoro-3-methoxyphenyl)pyridine-2-carboxylic acid comprising:
a) an herbicidally effective amount of halauxifen or 4-amino-3-chloro-5-fluoro-6-(4-chloro-2-fluoro-3-methoxyphenyl)pyridine-2-carboxylic acid, or an agriculturally acceptable salt or ester thereof; and
b) a compatible herbicide capable of safening the halauxifen or 4-amino-3-chloro-5-fluoro-6-(4-chloro-2-fluoro-3-methoxyphenyl)pyridine-2-carboxylic acid to the turfgrass.

2. The composition of claim 1, wherein (a) is halauxifen-methyl.

3. The composition of claim 1, wherein (a) is 4-amino-3-chloro-5-fluoro-6-(4-chloro-2-fluoro-3-methoxyphenyl)pyridine-2-carboxylic acid or salt or ester thereof.

4. The composition of claims 1-2, wherein the compatible herbicide is a synthetic auxin herbicide.

5. The composition of claim 3, wherein the synthetic auxin herbicide is selected from a group consisting of 2,4-D, 2,4-DB, clopyralid, dicamba, fluroxypyr, MCPA, MCPB, triclopyr, or agriculturally acceptable salts, esters, or mixtures thereof.

6. The composition of any of claims 1-5, wherein the weight ratio of (a) to (b) is from 1:100 to 25:1.

7. The composition of any of claims 1-5, wherein the weight ratio of (a) to (b) is from 1:80 to 10:1.

8. The composition of any of claims 1-5, wherein the weight ratio of (a) to (b) is from 1:50 to 1:1.

9. The composition of any of claims 1-8, further comprising an agriculturally acceptable adjuvant or carrier.

10. The composition of any of claims 1-9, wherein the turfgrass is glyphosate-tolerant, glufosinate-tolerant, dicamba-tolerant, phenoxy auxin-tolerant, pyridyloxy auxin-tolerant, aryloxyphenoxypropionate-tolerant, acetyl CoA carboxylase (ACCase) inhibitor-tolerant, imidazolinone-tolerant, acetolactate synthase (ALS) inhibitor-tolerant, 4-hydroxyphenyl-pyruvate dioxygenase (HPPD) inhibitor-tolerant, protoporphyrinogen oxidase (PPO) inhibitor-tolerant, triazine-tolerant, or bromoxynil-tolerant.

11. The composition of any of claims 1-10, wherein the turfgrass comprises multiple or stacked traits conferring tolerance to multiple chemistries and/or multiple modes-of-action.

12. A method for safening turfgrass susceptible to injury from halauxifen or 4-amino-3-chloro-5-fluoro-6-(4-chloro-2-fluoro-3-methoxyphenyl)pyridine-2-carboxylic acid, comprising applying to the turfgrass, contacting the vegetation, or area adjacent thereto with a herbicidal composition comprising:
(a) an herbicidally effective amount of halauxifen, 4-amino-3-chloro-5-fluoro-6-(4-chloro-2-fluoro-3-methoxyphenyl)pyridine-2-carboxylic acid, or an agriculturally acceptable salt or ester thereof; and
(b) a compatible herbicide capable of safening the halauxifen or 4-amino-3-chloro-5-fluoro-6-(4-chloro-2-fluoro-3-methoxyphenyl)pyridine-2-carboxylic acid to the turfgrass.

13. The method of claim 12, wherein the compatible herbicide is a synthetic auxin herbicide.

14. The method of claim 12, wherein the (a) and (b) are applied pre-emergently to the turfgrass or the undesirable vegetation.

15. The method of claim 12, wherein the (a) and (b) are applied post-emergently to the turfgrass or the undesirable vegetation.

16. The method of any of claims 12-15, wherein (a) is halauxifen-methyl.

17. The method of any of claims 11-14, wherein (a) is 4-amino-3-chloro-5-fluoro-6-(4-chloro-2-fluoro-3-methoxyphenyl)pyridine-2-carboxylic acid.

18. The method of any of claims 12-16, wherein (b) is 2,4-D, 2,4-DB, clopyralid, dicamba, fluroxypyr, MCPA, MCPB, triclopyr, or agriculturally acceptable salts, esters, or mixtures thereof.

19. The method of any of claims 12-16, wherein (b) is 2,4-D, dicamba, MCPA, or agriculturally acceptable salts, esters, or mixtures thereof.

20. The method of claim 12, wherein (a) is the halauxifen-methyl, and (b) is 2,4-D, dicamba, MCPA, or agriculturally acceptable salts, esters, or mixtures thereof.

21. The method of any of claims 12-20, wherein the weight ratio of (a) to (b) is from 1:100 to 25:1.

22. The method of any of claims 12-20, wherein the weight ratio of (a) to (b) is from 1:80 to 10:1.

23. The method of any of claims 12-20, wherein the weight ratio of (a) to (b) is from 1:50 to 1:1.

24. The method of any of claims 12-23, wherein the safened herbicidal composition further comprises an agriculturally acceptable adjuvant or carrier.

25. The method of any of claims 12-24, wherein the turfgrass is glyphosate-tolerant, glufosinate-tolerant, dicamba-tolerant, phenoxy auxin-tolerant, pyridyloxy auxin-tolerant, aryloxyphenoxypropionate-tolerant, acetyl CoA carboxylase (ACCase) inhibitor-tolerant, imidazolinone-tolerant, acetolactate synthase (ALS) inhibitor-tolerant, 4-hydroxyphenyl-pyruvate dioxygenase (HPPD) inhibitor-tolerant, protoporphyrinogen oxidase (PPO) inhibitor-tolerant, triazine-tolerant, or bromoxynil-tolerant.

26. The method of any of claims 12-25, wherein the turfgrass comprises multiple or stacked traits conferring tolerance to multiple chemistries and/or multiple modes-of-action.

27. The composition or method of any of claims 1-26, wherein the turfgrass is selected from a group consisting of perennial ryegrass (LOLPE), tall fescue (FESAR) and St. Augustine grass (STPSE).
